(19) United States
(12) Patent Application Publication
(10) Pub. No.: US 2009/0111980 A1
(43) Pub. Date: Apr. 30, 2009

(54) MODIFICATION OF AMINES AND ALCOHOLS

(75) Inventors: Jonas Fredrik Hafren, Stockholm (SE); Armando Cordova, Hagersten (SE)

Correspondence Address: CONNOLLY BOVE LODGE & HUTZ LLP, 1875 EYE STREET, N.W., SUITE 1100, WASHINGTON, DC, 20006, US

(73) Assignee: ORGANOCLICK AB, Stockholm (SE)

(21) Appl. No.: 11/722,668

(22) PCT Filed: Dec. 21, 2005
(86) PCT No.: PCT/SE05/01999

§ 371 Date: Mar. 24, 2008

Related U.S. Application Data
(60) Provisional application No. 60/638,997, filed on Dec. 23, 2004.

(51) Int. Cl. C08B 3/00

(52) U.S. Cl. 536/63

(57) ABSTRACT

A process for the modification of amines and alcohols, comprising (i) providing a substrate having amino groups or alcohol groups, wherein said substrate is, e.g., a polysaccharide; (ii) providing a modifying agent which is a lactone, an ester, a polyester, a carbonate, a polycarbonate, a lactide, a glycolide, an anhydride, an acid, a thioester or a carbamate; (iii) providing a catalyst which is, e.g., a amino acid or an organic acid; and (iv) reacting the substrate with the modifying agent in the presence of the catalyst.

### TECHNICAL FIELD

The present invention relates to a process for the modification of amines and alcohols.

### TECHNICAL BACKGROUND

The development of polymeric materials with tailored surface properties plays an important role in today's society. Essentially all devices and carriers contain different materials that have to be compatible with their surroundings. In addition, there is a need to develop chemistry that is based on renewable resources.

Aliphatic polyesters such as poly(ε-caprolactone) (PCL) and its copolymers are part of an important class of macromolecules for applications in biological and biomedical areas due to their desirable properties of biodegradability, biocompatibility and permeability. One of the most commonly used synthetic strategies for preparing these macromolecules is ring-opening polymerization (ROP) of ε-caprolactone (ε-CL) and other cyclic esters. The ROPs can be performed with transition-metal initiating compounds with high efficiency. However, removal of the metal contaminant, attached to the chain-end, of the polymer products has to be considered prior to application as biomaterials and microelectronics. Another method for the synthesis of aliphatic biodegradable polymers is lipase-catalyzed ROPs. More recently, nucleophilic amines and N-heterocyclic carbenes were utilized as catalysts for the ROP of cyclic ester monomers.

Asymmetric reactions that are mediated by small organic molecules have received increased attention in recent years. However, there are only few reports of non-selective organic acid-catalyzed ROPs and the amino and organic acid mediated direct esterification of amine and alcohol compounds. [F. Sanda, H. Sanada, Y. Shibasaki, T. Endo, Macromol. 2002, 35, 680; J. Liu, L. Liu, Macromol. 2004, 37, 2674.; J. Casas, P. V. Persson, T. Iversen, A. Córdova, Adv. Synth. Cat. 2004, 346, 1087] Furthermore, there is only one report of selective lactic acid-catalyzed ROP using monosaccharides as the initiators, which are soluble under the reaction conditions. [P. V. Persson, J. Schröder, K. Wickholm, H. Hedeström, T. Iversen, Macromol. 2004, 37, 5889]

U.S. Pat. No. 3,472,839 discloses a process for modifying cellulose with a composition comprising a modifying amount of carboxylic acid, and a catalytic amount of a hexahaloacetone-urea adduct.

### SUMMARY OF THE INVENTION

The object of the present invention is to provide direct homogeneous and heterogeneous organic acid- and amino acid-catalyzed modification of amines and alcohols.

Another object of the invention is to provide a direct process for the metal-free regio- and chemoselective modification of amines and alcohols using amino acids and organic acids as catalysts. Typical catalysts are natural and non-natural amino acids and derivatives thereof, oligopeptides, tartaric acid, lactic acid, citric acid, fumaric acid, malic acid, H₂O, α-hydroxy acids, sulfonic acids, tetrazoles and small organic acids. The catalysts were able to modify the amino- and alcohol groups of different compounds such as poly- and oligosaccharides, silica, aliphatic and aromatic amines and alcohols, proteins, peptides, dendrimers, fullerenes, poly-, oligo and mono-nucleotides, aliphatic and aromatic polymers and oligomers, and inorganic compounds with lactones, esters, polyesters, carbonates, polycarbonates, lactides, glycolides, anhydrides, acids, thioesters and carbamates.

Differently worded, an object of the present invention is the provision a process based on the use of non-toxic natural amino acids, peptides and derivatives thereof, tetrazoles, H₂O and small organic acids (including ascorbic acid, citric acid, tartaric acid, α-hydroxy acids, lactic acid and mandelic acid) as catalysts for the conversion of amines and alcohols with esters, carbonates, amides, carbamates, ureas and cyclic esters under environmentally benign reaction conditions.

From the above-mentioned, it may be gathered that the substrate is a compound of such size (e.g. a macromolecule) or conformation that there is demand for an improved modification process.

Hence, the objects of the present invention are provided by a process for the modification of amines and alcohols, comprising

(i) providing a substrate having amino groups or alcohol groups, wherein said substrate is a polysaccharide, an oligosaccharide, a silica, a protein, a peptide, a dendrimer, a fullerene, a polynucleotide, an oligonucleotide, a mononucleotides, an aliphatic or aromatic polymer or oligomer, a poly(hydroxyalkanoate), or a polyhydroxy compound;

(ii) providing a modifying agent which is a lactone, an ester, a polyester, a carbonate, a polycarbonate, a lactide, a glycolide, an anhydride, an acid, a thioester or a carbamate;

(iii) providing a catalyst which is an amino acid, a peptide or a derivative thereof, an oligopeptide, H₂O, a sulfonic acid, a tetrazole or an organic acid; and

(iv) reacting the substrate with the modifying agent in the presence of the catalyst.

One aspect of the invention is to modify alcohols (R═CO₂H, CO₂R′, alkyl, alkyne, alkenyl, polyhydroxy, aliphatic polymer, aromatic polymer, dendrimer, silica, polysaccharide, oligosaccharides, fullerenes, poly-, oligo and mono-nucleotides, aliphatic and aromatic oligomers and poly(hydroxyalkanoates); R¹=H or R) with acids (R₂=alkyl, alkyne, alkenyl, polyhydroxy, aryl, aliphatic polymer, aromatic polymer, aliphatic and aromatic oligomers and poly(hydroxyalkanoates) using amino acids and organic acids as the catalysts obtaining the corresponding ester-modified products (according to Scheme 1).

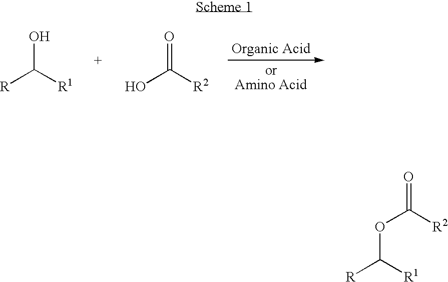

Another aspect of the invention is to modify amines (Scheme 2) (R═CO₂H, CO₂R′, alkyl, alkyne, alkenyl, polyhydroxy, aliphatic polymer, aromatic polymer, silica, dendrimer, polysaccharide, oligosaccharides, fullerenes, poly-, oligo and mono-nucleotides, aliphatic and aromatic oligomers and poly(hydroxyalkanoates); R1=H or R) with acids (R²=alkyl, alkyne, alkenyl, polyhydroxy, aryl, aliphatic polymer, aromatic polymer, aliphatic and aromatic oligomers and poly(hydroxyalkanoates) using amino acids and organic acids as the catalysts furnishing the corresponding amide functionalized products.

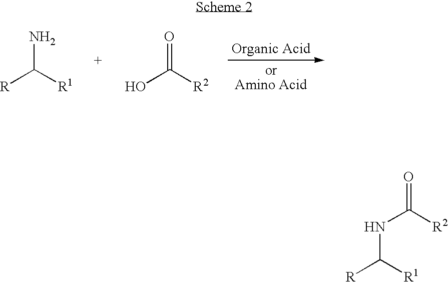

Another aspect of the invention is to modify alcohols (R═CO₂H, CO₂R′, alkyl, alkyne, alkenyl, polyhydroxy, aliphatic polymer, aromatic polymer, dendrimer, silica, polysaccharide, oligosaccharides, fullerenes, poly-, oligo and mono-nucleotides, aliphatic and aromatic oligomers, and poly(hydroxyalkanoates); R¹═H or R) with esters, carbonates and carbamates (R²=alkyl, alkyne, alkenyl, polyhydroxy, aryl, aliphatic polymer, aromatic polymer, aliphatic and aromatic oligomers and poly(hydroxyalkanoates), aliphatic or aromatic amine, alkoxy; R³=alkyl, aryl, vinyl) using amino acids and organic acids as the catalysts obtaining the corresponding modified products (Scheme 3).

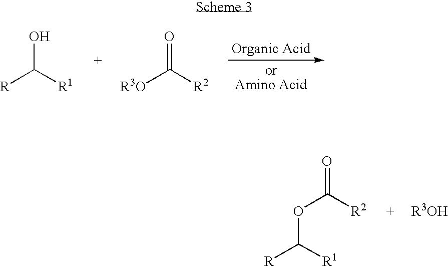

Another aspect of the invention is to modify amines (R═CO₂H, CO₂R′, alkyl, alkyne, alkenyl, polyhydroxy, aliphatic polymer, dendrimer, aromatic polymer, silica, polysaccharide, oligosaccharides, fullerenes, poly-, oligo and mono-nucleotides, aliphatic and aromatic oligomers, and poly(hydroxyalkanoates); R¹═H or R) with esters, carbonates and carbamates (R²=alkyl, alkyne, alkenyl, polyhydroxy, aryl, aliphatic polymer, aromatic polymer, aliphatic and aromatic oligomers and poly(hydroxyalkanoates), aliphatic or aromatic amine, alkoxy; R³=alkyl, aryl, vinyl) using amino acids and organic acids as the catalysis obtaining the corresponding modified products (Scheme 4).

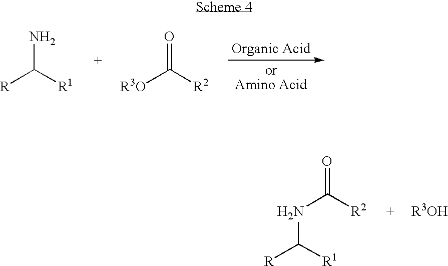

Another aspect of the invention is to modify amines and alcohols (Scheme 5) (R═CO₂H, CO₂R′, alkyl, alkyne, alkenyl, polyhydroxy, aliphatic polymer, dendrimer, aromatic polymer, silica, polysaccharide, oligosaccharides. fullerenes, poly-, oligo and mono-nucleotides, aliphatic and aromatic oligomers, and poly(hydroxyalkanoates); R¹═H or R) with thio-esters (R²=alkyl, alkyne, alkenyl, polyhydroxy, aryl); R³=alkyl) using amino acids and organic acids as the catalysts obtaining the corresponding modified products.

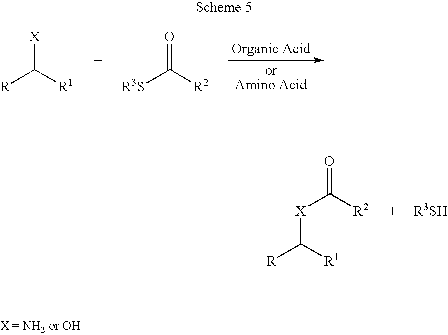

Another aspect of the invention is to use amines and alcohols (R═HO, CO₂H, CO2R′, alkyl, alkyn, alkenyl, polyhydroxy, aliphatic polymer, aromatic polymer, dendrimer, silica, polysaccharide, oligosaccharides, fullerenes, poly-, oligo and mono-nucleotides, aliphatic and aromatic oligomers, and poly(hydroxyalkanoates); R1═H or R) as initiators for the ring-opening polymerization (ROP) of cyclic monomers (n=0-3, Y=CH₂, CHOH, O, NH, CH-halogen, Z=CH₂, CHOH, O, NH, CH-halogen, R³=alkyl, alkenyl; glycolide, lactide) and mixtures thereof using amino acids and organic acids as catalysts furnishing the corresponding amine and alcohol initiated polymers.

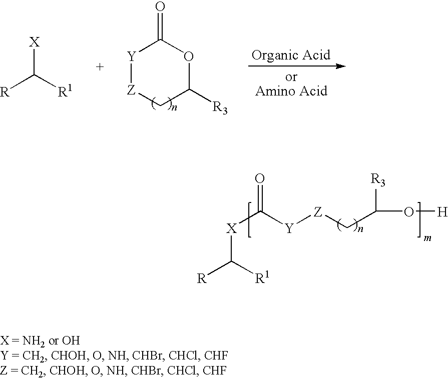

Another aspect of the invention is that the α-hydroxy acids can catalyze autocatalytic transestrifications and ring-opening polymerizations. For example, lactic acid catalyze the autocatlytic formation of lactide and subsequent ROP of poly(lactide). In addition, the α-hydroxy acids auto-catalyze their esterification of alcohols and aminoacylation of amines, respectively. Accordingly, if the catalyst is an α-hydroxy acid, the modifying agent may be the same compound.

Another aspect of the invention is that the products derived from the amino and organic acid-catalyzed transformations can have different functionalities that serve as handles for further modification. For example, alkynes or azides can be reacted with different azides or alkynes, respectively, in transition metal-catalyzed regioselective Huisgen 1,3-dipolar cycloadditions to yield new triazole linked substituents (click chemistry) (Lewis et al., Angewandte Chemie Int. Ed. 2002, 41, 1053). Another handle for modifications are phenols that can take part in Mannich-type reactions between formaldehyde and different anilines to yield new alkyl aryl amine-linked substituents (Joshi et al. J. Am. Chem. Soc. 2004, 126, 15942).

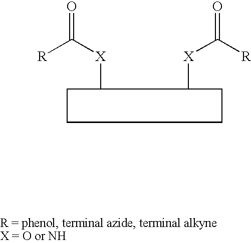

Another aspect of the invention is that the amino acids and organic acids as catalysts are selective. For example, primary alcohols are modified with high selectivity in the presence of secondary alcohols. Furthermore, aliphatic alcohols are modified with high chemoselectivity in the presence of phenols. Aliphatic amines are also modified with high chemoselectively in the presence of anilines and phenols.

Another aspect of the invention is that all the previously described transformations can be and are performed with enantiomerically pure reactants yielding enantiomerically pure products.

An embodiment of the present invention refers to heterogeneous (i.e. solid phase substrate and liquid phase modifying agent) catalyzed modification of amines and alcohols. For example, tartaric acid catalyzed the direct ring-opening polymerization (ROP) of ε-caprolactone (ε-CL) with solid cellulose as the initiator. The mild ROPs were performed without solvent, and are operationally simple, inexpensive and environmentally benign.

There are no reports of metal-free chemically controlled solid phase cellulose derivatization for the preparation of functional polysaccharide products. However, probably of concerns about the solid substrates and assumed low selectivity and efficiency of such a process, chemists, in both pure and applied fields, have not given this potential transformation the special attention it deserves. Although, these direct transformations would plausibly include high selectivity be environmentally benign and non-toxic.

None of the reports presented in the background section of this description include the modification of solid substrates, which are not solubilized. The employment of non-toxic small organic molecules has the potential for allowing environmentally benign reaction conditions and sustainable chemistry.

The process of the present invention is suitable for modification of several polysaccharides, e.g. lignocellulose, hemicellulose or starch. A source of polysaccharides may be wood.

### Process for Organic Acid Catalyzed Hetereogeneous Modifications

Neat cyclic-monomer (1-100 equivalents) and organic acid (1-10 mol % of the monomer) were mixed in oven-dried glass vials. The mixture was heated between 30-240° C. and when the organic acid was dissolved, known amount of alcohol and amino-functionalized solid substrates (1 equivalent) were introduced and soaked in the mixture. The vials were sealed with screw-caps, and the reactions were run for 6-48 h. After cooling, the non-immobilized polymer and organic acid were extracted (soxhlet) from the samples. The samples were dried prior to further analysis. All new compounds were analyzed by NMR, FT-IR and the polymers were analyzed by MALDI-TOF MS and GPC.

In addition, the alcohol and amino-functionalized solid substrates were reacted with organic acids, esters, thioesters, carbonates anhydrides and carbamates in the presence of a catalytic amount of amino acid or organic acid (1-10 mol %) under the above reaction conditions to generate the corresponding modified products. After cooling, the crude products were extensively extracted (soxhlet) from the samples. The samples were dried prior to further analysis. All new compounds were analyzed by NMX and FT-IR.

### Process for Organic Acid Catalyzed Homogeneous Modifications

Soluble alcohol or amine (1 equiv.), organic acid (1-10 mol %) and cyclic monomer (1-100 equiv.) were mixed and heated between 35-240° C. under stirring. The ROPs were quenched by allowing the reaction temperature to reach room temperature. The crude polymer products were purified by dilution with THF followed by precipitation in cold methanol to give the desired products. All new compounds were analyzed by NMR, FT-IR, MALDI-TOF MS and GPC.

In addition, soluble alcohols or amines (1 equiv.) and organic acids, esters, thioesters, carbonates anhydrides and carbamates (1-100 equiv.) were mixed in the presence of a catalytic amount of amino acid or organic acid (1-10 mol %) and heated between 35-240° C. under stirring to furnish the desired compounds. The reactions were allowed to reach room temperature and quenched by extraction with EtOAc and brine. The products were purified by standard column chromatography. All new compounds were analyzed by NMR, GC and FT-IR.

### BRIEF DESCRIPTION OF THE DRAWINGS

FIG. 1 shows FTIR spectra from Example 1 of cotton (a) and paper (b) cellulose fibers, PCL-grafted cellulose, blanks (without organic acid catalyst) and untreated references.

FIG. 2 shows FT-IR from Example 3 of PCL derivatized TMP (PCL-TMP), TMP with ε-CL without catalyst (TMP-blank) and starting paper material.

FIG. 3 shows the molecular weight distribution from Example 3 of non-immobilised PCL, analyzed by MALDI-TOF MS.

FIG. 4 shows FT-IR spectra from Example 4 of PLLA-derivatized cellulose, blank (without tartaric acid catalyst) and untreated reference.

FIG. 5 shows FT-IR spectra from Example 4 of D-mandelic acid-derivatized cellulose, blank (without tartaric acid catalyst) and untreated reference.

### EXAMPLES

### Example 1

### Organic Acid-Catalyzed Modification of Polysaccharide

Substrate: Cellulose (from paper and cotton)
Modifying agents: ε-caprolactone, pentynoic acid and hexadecanoic acid
Catalyst: Tartaric acid

Materials. Whatman 1 Filter paper (Whatman International), and ethanol-extracted commercial cotton were used as cellulose sources. Pieces cut from the filter paper and cotton were dried overnight at 105° C. prior to use. The ε-caprolactone (ε-CL; Sigma-Aldrich) was used after drying over activated molecular sieves, and tartaric acid (Sigma-Aldrich), pentynoic acid and hexadecanoic acid were used as delivered. The reactions were performed in dried glass tubes sealed with plugs containing an activated drying agent and were monitored by thin-layer chromatography (TLC). For TLC, Merck 60 F254 silica-gel plates were used and compounds were visualized by irradiation with UV light and/or by treatment with a solution of phosphomolybdic acid (25 g), Ce(SO₄)₂.H₂O (10 g), conc. H₂SO₄ (60 mL) and H₂O (940 mL), followed by heating. ¹H NMR and ¹³C NMR spectra were recorded on a Varian AS 400 spectrometer. Chemical shifts are given in relative to tetramethylsilane (TMS; δ=0 ppm for ¹H and δ=77.0 ppm for ¹³C); coupling constants, J, are given in hertz. The spectra were recorded in CDCl₃ at room temperature.

Organic Acid-Catalyzed Derivatization of Cellulose. Neat ε-CL (2.5 mmol) and tartaric acid (0.25 mmol) were mixed in oven-dried glass vials. The mixture was heated to 120° C. When the tartaric acid had dissolved, known amounts of paper and cotton samples (about 20 mg) were introduced and soaked in the mixture. The vials were sealed with screw caps, and the reactions were run for 6 h. After cooling, the nonimmobilized poly(ε-caprolactone) (PCL) and tartaric acid were extracted (Soxhlet) from the samples (dichloromethane and water). The samples were dried prior to further analysis. Controls without tartaric acid and ε-caprolactone were also performed. Cellulose was also derivatized with hexadecanoic acid (0.25 mmol) and pentynoic acid (0.25 mmol), as outlined above for ε-CL. Chloroform was used instead of dichloromethane in the Soxhlet extractions of hexadecanoic acid.

FTIR Analysis of the PCL-Cellulose Products. The derivatizations were confirmed by FTIR spectroscopy. Cellulose and PCL-cellulose samples were analyzed for absorbance directly, without prior sample handling, using a Perkin-Elmer Spectrum One FTIR spectrophotometer. Each sample was subject to 32 averaged scans.

Electron Microscopy of PCL-Cellulose. Dry PCL-paper, PCL-cotton and references were mounted on stubs and gold-coated using a Polaron E5000 sputter device. The samples were analyzed in a Philips XL 30 environmental scanning electron microscope (ESEM) operating in conventional SEM mode.

NMR and MS Analysis of Nonimmobilized Poly(ε-Caprolactone). Soxhlet-extracted PCL was vacuum dried, re-dissolved in THF and precipitated with methanol. The precipitate was collected and vacuum dried. The dry PCL was analyzed by NMR spectroscopy.

### PCL-1

¹H NMR (CDCl₃): δ=1.34 (m, CH₂, PCL chain), 1.61 (m, CH₂, PCL chain, 2.26 (t, J=6.0 Hz, CH₂CO, PCL chain), 3.64 (t, J=5.0 Hz, 2H, CH₂OH, PCL end group), 4.05 (t, J=5.2 Hz, CH₂OR).

### ¹³C NMR: δ=24.7, 24.8, 25.4, 25.7, 28.3, 28.5, 32.4, 34.3, 62.8, 64.3, 173.7.

Results and Discussion. We initially screened different organic acids and amino acids for their ability to catalyze the ROP of ε-CL from cellulose fibers. We found that tartaric acid, citric acid, lactic acid and proline exhibited catalytic activity and furnished PCL. Tartaric acid was the most efficient catalyst for the production of PCL-grafted cellulose (Scheme A).

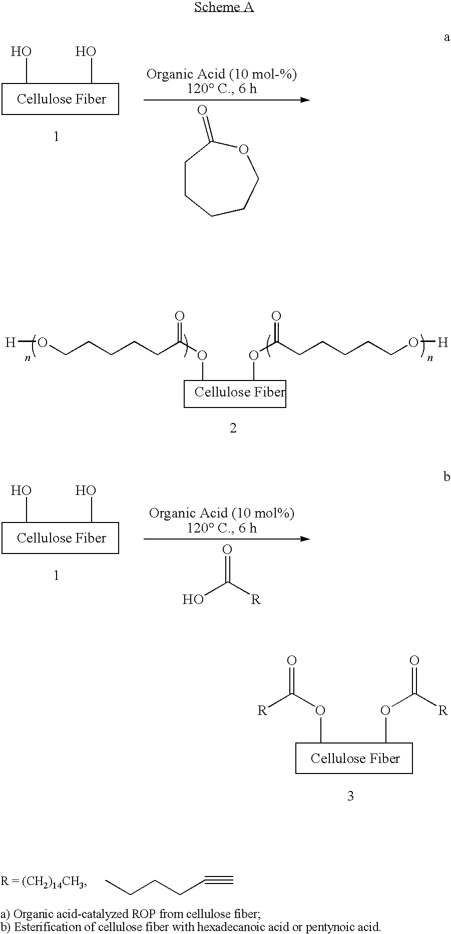

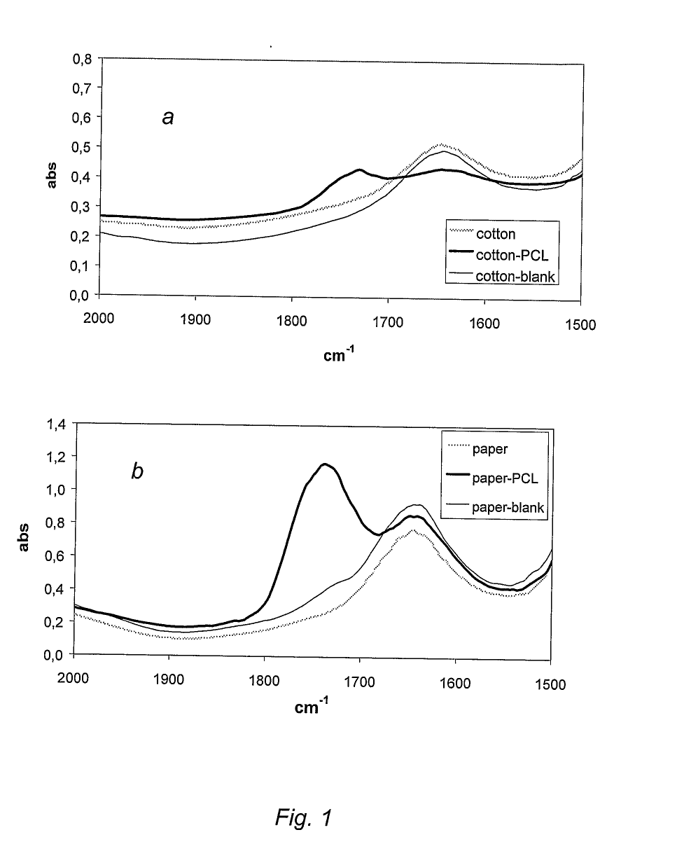

Reactions without organic catalyst were also performed by mixing ε-CL with cotton and paper cellulose 1 at 120° C. (blank fiber). In this case, no significant amount of PCL was formed. To verify successful surface grafting, FTIR analyses were performed with the PCL-cellulose fibers 2 (FIG. 1). The analysis clearly revealed a carbonyl peak at 1730 cm⁻¹ due to the ester groups of the grafted fiber 2 as compared with the reference samples. This shows that the PCL chain had been covalently attached to the cellulose fibers. Gravimetric determinations of the cellulose filter paper samples before and after ε-CL polymerizations clearly revealed an 11% weight gain. Nonimmobilized PCL was isolated in >90% yield and analyzed by NMR spectroscopy. The PCL-grafted cellulose samples were tested for hydrophobicity. Cotton fiber (1), cotton-PCL (2) and cellulose-blank samples were placed on the surface of water-filled cups. The cotton fiber 1 and blank sample absorbed water and sank immediately to the bottom. In contrast, PCL fiber 2 did not absorb water and floated on the water surface. The filter-paper hydrophobicity was analyzed by the contact-angle and water-adsorption properties of water droplets (4 mL) added to the paper surface. The untreated reference and blank sample without organic acid catalyst were hydrophilic; the water droplets were rapidly adsorbed by the cellulose. The filter-PCL product was strongly hydrophobic, with a contact angle of 114° from start. After 10 s the contact angle was 105°, and only 11% of the water volume had been adsorbed. Cellulose is naturally hydrophilic, hence the hydrophobic properties of the cellulose-PCL products strongly corroborate a successful cellulose derivatization by tartaric acid catalyzed ROP of ε-CL. Thus, PCL, and not tartaric acid, is the main grafting molecule on the cellulose hydroxyl groups that causes the carbonyl peak in the FTIR spectrum (FIG. 1), since the sample surface has become hydrophobic.

To further verify the solid-state esterification of cellulose, we performed organic acid-catalyzed esterification of cotton fibers (1) with hexadecanoic acid and pentynoic acid according to the ROP experimental procedure. Hexadecanioc acid and pentynoic acid esterified cellulose fibers 3 were obtained after extensive Soxhlet washing. FTIR analyses of the resulting modified fiber 3 revealed a carbonyl peak at 1730 cm⁻¹ corresponding to the ester groups of the grafted fiber, which further supports the covalent attachment of PCL to cellulose fibers.

We also investigated whether prolonged heating of ROP ε-CL mixed with cellulose fibers without catalysts would furnish the cellulose-PCL fibers. However, PCL esterification of cellulose proceeded slowly without the organic acid catalyst. Furthermore, the insolubility of cellulose fibers in ε-CL or neutral solvents provides certain challenges for cellulose-fiber functionalization.

A plausible mechanism for the ROP of ε-CL and the esterification of cellulose is proton activation of the monomer by the organic acid, followed by initiation of the activated monomer by the hydroxyl groups of the cellulose fiber 1, which results in transesterification and ring-opening of the monomer. Next, chain propagation occurs by transesterification of the proton-activated monomer and the growing PCL chain. In addition, the initiation of the protonactivated monomer also occurs by the more reactive ahydroxy groups of the tartaric acid and residual water to give organic-acid-initiated PCL.

### Example 2

### Organic Acid-Catalyzed Modification of Dendrimer

Substrate: 2,2-bis(hydroxymethyl)propanoic acid
Modifying agent: ε-caprolactone
Catalyst: Lactic acid

Materials and Methods. Chemicals and solvents were either purchased puriss p.A. from commercial suppliers or purified by standard techniques and dried either over P₂O₅ in a desiccator or over activated molecular sieves prior to use. The reactions were performed in dried glass tubes sealed with plugs containing activated drying agent. For thin-layer chromatography (TLC), silica gel plates Merck 60 F254 were used and compounds were visualized by irradiation with UV light and/or by treatment with a solution of phosphomolybdic acid (25 g), Ce(SO₄)₂.H₂O (10 g), conc. H₂SO₄ (60 mL), and H₂O (940 mL) followed by heating. Flash chromatography was performed using silica gel Merck 60 (particle size 0.040-0.063 mm), ¹H NMR and ¹³C NMR spectra were recorded on a Varian AS 400. Chemical shifts are given in δ relative to tetramethylsilane (TMS), the coupling constants J are given in Hz. The spectra were recorded in CDCl₃ or CD₃OD as solvent at room temperature, TMS served as internal standard (δ=0 ppm) for ¹H NMR, and CDCl₃ was used as internal standard (δ=77.0 ppm) for ¹³C NMR.

GPC. Samples were diluted in tetrahydrofuran to a concentration of 2 mg/mL and filtered through a 0.45 μm PTFE membrane prior to injection into the GPC system (Rheodyne 7125 injector, 20 μL 4 sample loop, Waters HPLC pump 510, and a Waters 410 differential refractometer). The separation was accomplished by three columns connected in series (50, 100 and 500 Å, Ultrastyragel, Waters). Tetrahydrofuran was used as eluent at a flow rate of 1 mL/min. The GPC system was calibrated using polystyrene standards, 266-34,500 Da (Machery Nagel). All GPC measurements were performed in duplicates.

MALDI-TOF MS. 10 μL of samples diluted to 10 mg/mL with THF were mixed with 40 μL of a matrix solution (50 mg/mL 2,5-dihydroxybenzoic acid dissolved in a one-to-one mixture of methanol and water). 0.5 μL of this solution was applied to the sample probe and inserted to the spectrometer (Hewlett Packard G20205A LD-TOF) after removal of the solvent under reduced pressure. Preparation of dendrimer 1: The dendrimer was synthesized according to literature procedures (Ihre, H.; Hult, A.; Fréchet, J. M. J.; Gitsov, I. Macromolecules, 1998, 31, 4061; Malkoch, M.; Malmström, E.; Hult, A. Macromolecules 2002, 35, 8307).

Procedure for the L-lactic acid-catalyzed synthesis of 2: Hexahydroxy-functional dendrimer 1 (30 mg, 0.046 mmol), L-lactic acid (33 mg, 0.37 mmol) and ε-CL (420 mg, 3.7 mmol) were mixed and heated to 120° C. under stirring. After 1 h reaction, all monomer had been consumed according to GPC. The polymer was purified by dilution with THF followed by precipitation in methanol to give a white powder. All spectroscopic data of 2 were identical to those previously reported. ¹H NMR (CDCl₃): δ=1.34 (m, CH₂, PCL chain), 1.61 (m, CH₂, PCL chain), 2.26 (t, J=6.0 Hz, CH₂CO, PCL chain), 2.21 (s, 3H, CH₃, dendrimer), 3.64 (t, J=5.0 Hz, 12H, CH₂OH, PCL end-group), 4.05 (t, J=5.2 Hz, CH₂OR), 4.36 (bs, 12H, CH₂OR, dendrimer), 6.88 (d, J=6.9 Hz, 6H, ArH, dendrimer), 7.07 (d, J=6.9 Hz, 6H, ArH, dendrimer); ¹³C NMR: δ=17.7, 24.4, 25.4, 28.2, 32.2, 34.0, 46.6, 51.5, 62.2, 64.0, 65.1, 120.6, 129.6, 146.2, 148.6, 171.3, 172.7, 173.4.
Chemoselectivity Test: Procedure for the synthesis of PCL in the presence of 2-(4-hydroxyphenyl)ethanol: 3.5 mmol ε-CL, 0.1 mmol 2-(4-hydroxyphenyl)ethanol and tartaric acid (0.07 mmol, 2 mol % based on ε-CL) were mixed and heated to 120° C. The reaction was terminated after 24 hours and the crude was analyzed by NMR and GPC. ¹H NMR (CDCl₃): δ=1.38 (m, CH₂, PCL chain), 1.69 (m, CH₂, PCL chain), 2.26 (t, J=6.0 Hz, CH₂CO, PCL chain), 2.85 (t, J=7.2 Hz, 2H, CH2, initiator), 3.65 (t, J=6.6 Hz, 2H, CH₂OH, PCL end-group), 4.06 (t, J=^{6.6} Hz, CH₂OR, PCL chain), 4.25 (t, J=6.9 Hz, 2H, CH₂OR, initiator), 6.77 (d, J=8.5 Hz, 2H), 7.06 (d, J=8.5 Hz, 2H); ¹³C NMR: δ=24.2, 24.4, 25.2, 25.3, 27.9, 28.1, 32.1, 33.9, 34.0, 62.3, 64.0, 64.9, 115.2, 129.0, 129.7, 154.9, 173.3, 173.4.

Preparation of Dendrimer-Like PCL (Scheme B).

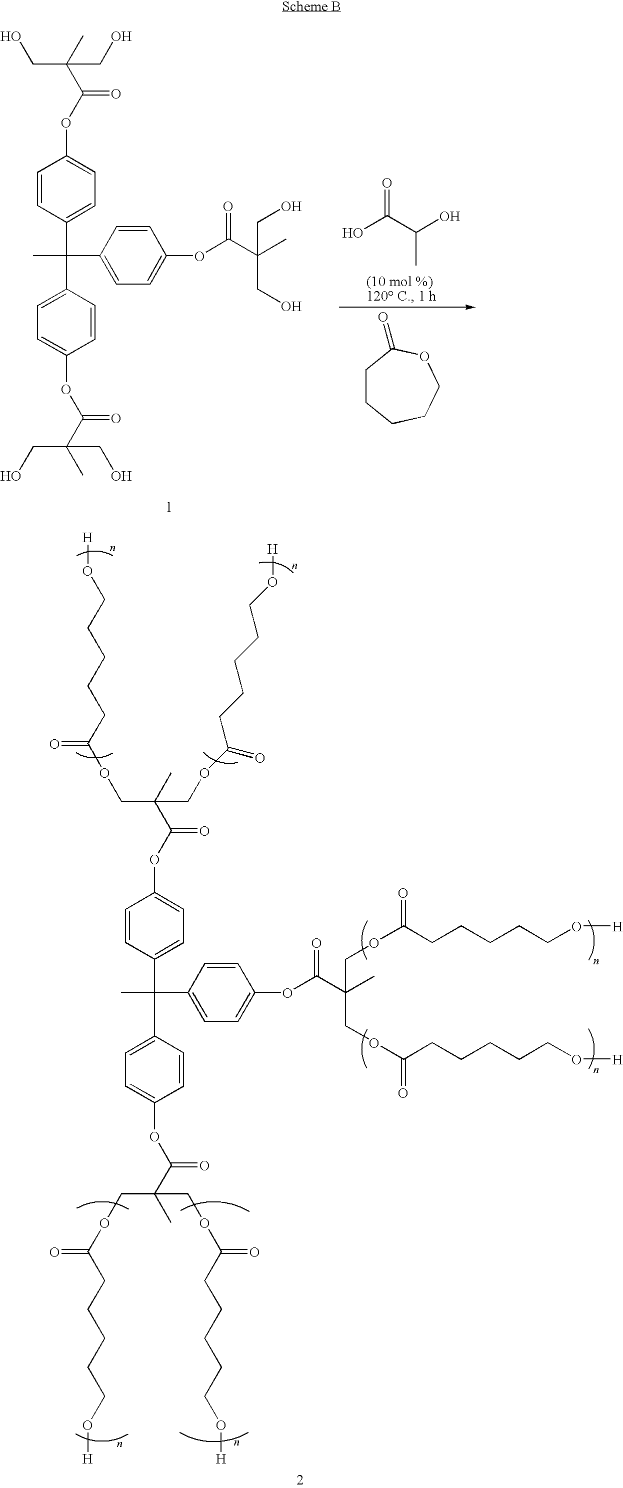

To demonstrate the versatile potential of this reaction system, the first generation bis-MPA dendrimer 1 was employed as the initiator in the polymerization of ε-CL catalyzed by L-lactic acid at 120° C. After 1 hour, complete monomer conversion had occurred as determined by GPC. After precipitation in cold methanol, the dendrimer-like polymer 2 was afforded in 90% yield. NMR analysis of 2 revealed that all of the hydroxyl groups of 1 had initiated the ROP of ε-CL. The polymer 2 had a DP of 20 monomer units on each polymer arm with a polydispersity index (PDI) of 1.48 and an average Mw of 12 400 Da as determined by NMR and GPC.

### Example 3

### Organic Acid-Catalyzed Modification of Polysaccharide

Substrate: Lignocellulose (from paper)
Modifying agent: ε-caprolactone
Catalyst: Tartaric acid

Paper Derivatization.

From commercial newsprint (“Standard News” paper, SCA, Sweden) of thermomechanical wood pulp (TMP, of Norway spruce), known amount (of about 15 mg) were cut and dried overnight at 105° C. prior use. Dried (over activated molecular sieves) ε-caprolactone (2.5 mmol, Sigma-Aldrich) and tartaric acid (0.25 mmol, Sigma-Aldrich) were mixed in oven-dried glass vials. The mixture was heated to 120° C. and when the tartaric acid was dissolved, the paper samples (dry) were introduced. The glass-vials were sealed with screw-caps, and the reaction were let for 6 h. After cooling, the non-immobilized PCL and the tartaric acid were extracted (soxhlet) from the paper samples using tetrahydrofuran, dichloromethane and water. The paper samples were dried prior further analysis. Control experiments were performed; with tartaric acid in DMSO and TMP-paper without ε-CL, TMP paper and ε-CL without tartaric acid.

Analysis of the Derivatized Lignocellulose Product.

Derivatizations of the samples were confirmed using FTIR. Underivatized paper samples (blank) and derivatized paper samples were analyzed for absorbance directly, without prior sample handling, using a Perkin-Elmer Spectrum One FT-IR spectrophotometer. Each sample was subject to 32 averaged scans.

NMR Analysis of Non-Immobilized Poly(ε-Caprolactone).

Soxhlet extracted PCL was vacuum dried, re-dissolved in THF and precipitated with methanol. The precipitate was collected, vacuum dried, and analyzed by ¹H NMR and ¹³C NMR (recorded on Varian AS 400 spectrometer). Chemical shifts are given in δ relative to tetramethylsilane (TMS), the coupling constants J are given in Hz. The spectra were recorded in CDCl₃ as solvent at room temperature, TMS served as internal standard (δ=0 ppm) for ¹H NMR, and CDCl₃ was used as internal standard (δ=77.0 ppm) for ¹³C NMR. PCL: ¹H NMR (CDCl₃): δ=1.34 (m, CH₂, PCL-chain), 1.61 (m, CH₂, PCL-chain), 2.26 (t, J=6.0 Hz, CH₂CO, PCL-chain), 3.64 (t, J=5.0 Hz, 2H, CH₂OH, PCL-end-group), 4.05 (t, J=5.2 Hz, CH₂OR); ¹³C NMR: δ=24.7, 24.8, 25.4, 25.7, 28.3, 28.5, 32.4, 34.3, 62.8, 64.3, 173.7.

MALDI-TOF MS Analysis of Non-Immobilized Poly (ε-Caprolactone).

Dry PCL was dissolved in acetonitrile (2 mg mL⁻¹) and mixed 1:1 with a matrix solution of 100 mM 2,5-dihydroxybenzoic acid in aceton, water and methanol (1:1:1). The sample solutions (10 μL) were analyzed for molecular weight by MALDI-TOF mass spectroscopy using a Bruker Reflex III.

FT-IR Analysis of PCL-TMP.

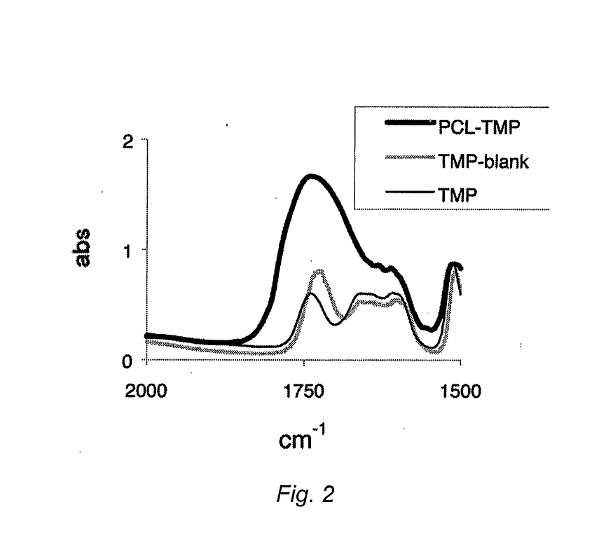

The lignocellulose initiated bulk ROP of ε-CL were analyzed by FT-IR, which confirmed the successful lignocellulosic derivatization. A general presentation of the polymerization of PCL from a lignocellulosic material is shown in Scheme C. In FIG. 2, both untreated starting lignocellulosic material (TMP paper) and a control (TMP paper treated with ε-caprolactone without organic acid catalyst present) were analyzed by FT-IR, together with the PCL-TMP product. After the reaction there was an evident carbonyl peak (at 1730 cm-1) present in the PCLTMP sample that can be attributed the polyester polymer.

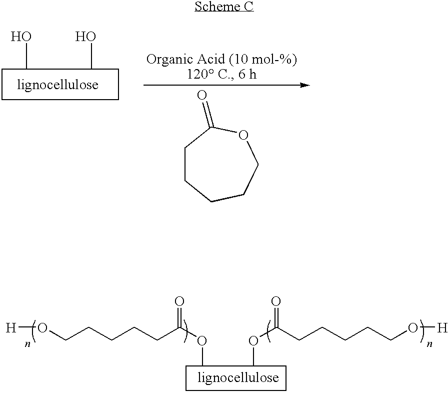

Molecular Weight of PCL.

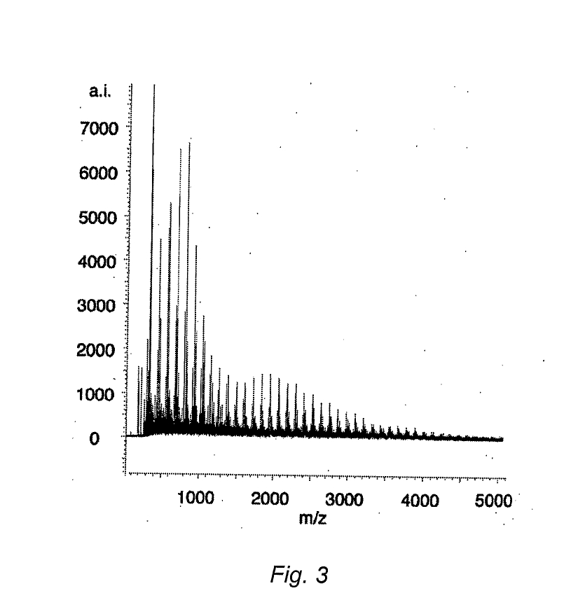

The non-immobilized polymers, extracted from the PCLTMP, were analyzed by matrix-assisted laser desorption ionization time-of-flight mass spectrometry (MALDI-TOF MS) for molecular weight (FIG. 3). The analyses clearly revealed that tartaric acid catalyzed ROP of ε-CL furnished PCL. In addition, ¹H NMR analyses of the crude reaction mixture revealed that complete conversion had occurred and that the precipitated PCL had an average molecular weight (Mₙ) of 2754 Da that corresponds to a degree of polymerization (DP) of 24 monomer units.

Gravimetric Analyses of PCL-TMP.

The weight of the paper samples increased 94% (mean of duplicates) after treatments, also corroborating a successful derivatization. In the control sample in which tartaric acid had been omitted from the reaction the paper samples gained 1% (mean of duplicates), indicating insignificant unspecific ε-CL physio-adsorption to the fibers and slow thermal-driven spontaneous polymerization of ε-CL or derivatization of TMP.

### Example 4

### Organic Acid-Catalyzed Modification of Ppolysaccharide

Substrate: Cellulose (from paper)
Modifying agent: L-lactid, D-mandelic acid
Catalyst: Tartaric acid, D-mandelic acid

This study presents a novel Bronsted acid-catalyzed environmentally benign and solvent-free cellulose-initiated direct ROP of L-lactide and chiral derivatization with D-mandelic acid according to Scheme D.

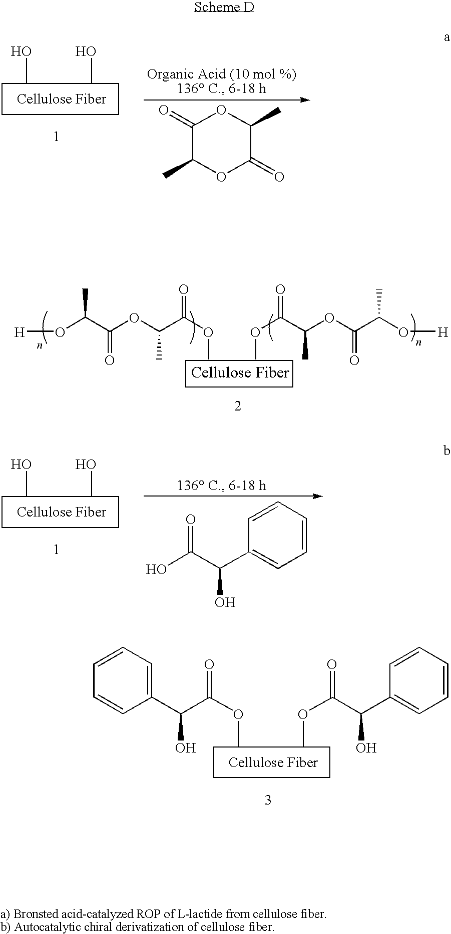

Materials. Filter paper, Whatman 1 (Whatman International) was used as cellulose. Cut pieces from the filter paper were dried overnight at 105° C. The L-lactide (Sigma-Aldrich) was kept refrigerated until use, and D-mandelic acid (α-hydroxyphenylacetic acid) (Sigma-Aldrich) and tartaric acid (Sigma-Aldrich) were vacuum stored over silica. All chemicals were used as delivered. Both D-tartaric and L-tartaric acid with >98% ee were used as catalysts (Sigma-Aldrich). The reactions were performed in dried glass tubes sealed with plugs containing activated drying agent. ¹H NMR and ¹³C NMR spectra were recorded on Varian AS 400. Chemical shifts are given in δ relative to tetramethylsilane (TMS), the coupling constants J are given in Hz. The spectra were recorded in CDCl₃ as solvent at room temperature, TMS served as internal standard (δ=0 ppm) for ¹H NMR, and CDCl₃ was used as internal standard (δ=77.0 ppm) for ¹³C NMR. Optical rotations were recorded on a Perkin Elemer 241 Polarimeter (λ=589 nm, 1 dm cell). GC was carried out using a Varian 3800 GC Instrument.

Cellulose-Initiated ROP of L-Lactic Acid.

L-lactide (2.5 mmol) and L-tartaric acid (0.25 mmol) were mixed neat in oven-dried glass vials. The mixture was heated to 136° C., next a known amount cellulose paper (20 mg) were introduced and soaked in the mixture. The vials were sealed with screw-caps, and the reactions were run for 6-18 h. After cooling, the non-immobilized poly(L-lactic acid) (PLLA) and tartaric acid were soxhlet extracted (dichloromethane and water). Control with omitted tartaric acid was also produced. Cellulose was also derivatized by D-mandelic acid (0.25 mmol), as outlined above, except that ethanol was used instead of dichloromethane in the soxhlet extractions.

Analysis of the Derivatized Cellulose.

The carbonyl-groups in the PLLA and D-mandelic acid cellulose samples were analyzed using FT-IR. Underivatized cellulose samples (blank) and derivatized samples were analyzed for absorbance directly, without further sample handling, using a Perkin-Elmer Spectrum One FT-IR spectrophotometer. Each sample was subject to 32 averaged scans. The hydrophobic properties of PLLA derivatized cellulose were tested by contact angle and water-droplet absorption measurements using an automated contact angle tester (Fibro 1100 DAT), according to standard ASTM test method (D5725) for surface wettability and absorbency of sheeted materials. The D-mandelic acid derivatized cellulose-paper was illuminated by UVlight and photographed.

Analysis of Non-Immobilized Poly(L-Lactic Acid).

Soxhlet extracted PLLA was vacuum dried, re-dissolved in THF and precipitated with methanol. The precipitate was collected and vacuum dried. The dry PLLA was analyzed by NMR. PLLA: ¹H NMR (CDCl₃): δ=1.57 (d, J=6.8 Hz, 33H, CH₃, PLLA-chain), 4.35 (m, 1H, CHOH, PLLA-end-group), 5.15 (m, 22H, CHOR, PLLA-chain); ¹³C NMR: δ=16.9 (CH₃), 67.1 (CHOH), 69.3 (CHOR, 169.9 (COOR). [α]_{D}²³=−128.9 (c=1.1, CHCl₃).

PLLA Derivatization of Cellulose.

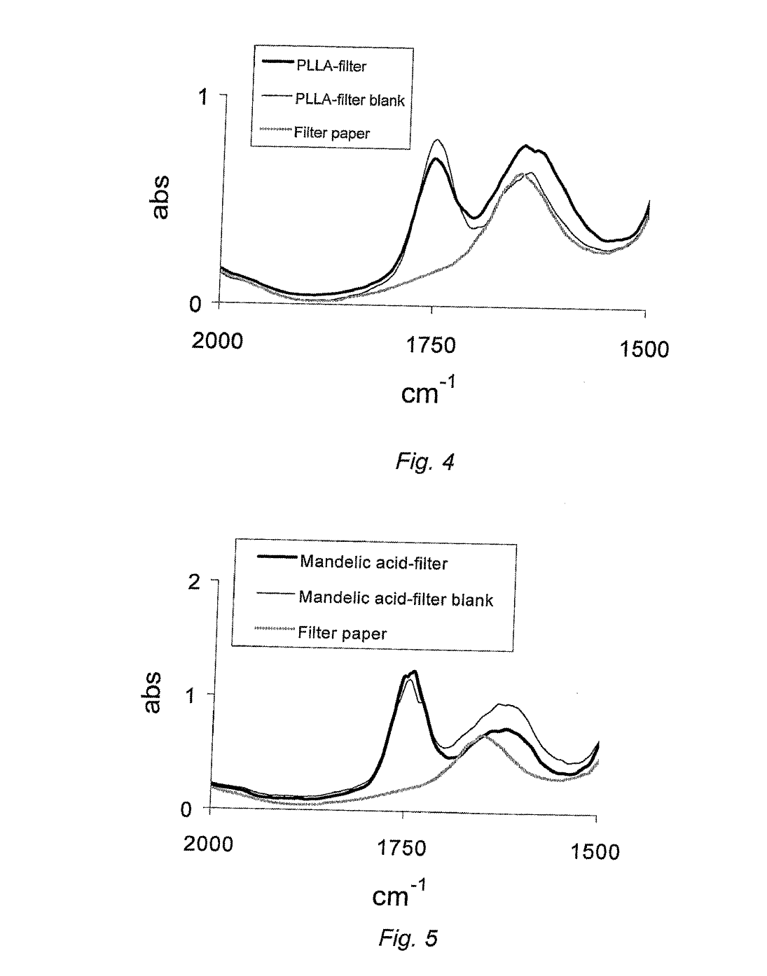

The lactone used for the cellulose derivatization was an enantiomerically pure cyclic lactone, L-lactide, which in bulk ROP form PLLA. A plausible mechanism for the ROP from polysaccharides is an initial proton-activation of the L-lactide by the Bronsted acid then proton-activation of L-lactide initiate ring-opening and from the primary hydroxyl groups of the polysaccharides a covalently attached L-lactide to the cellulose is furnished. Chain-propagation occurs via transesterification between the proton-activated monomer and the growing PLLA polymer. The cellulose initiated bulk ROPs of L-lactide were analyzed by FT-IR, which confirmed the successful polysaccharide derivatization (FIG. 4). The PLLA modification of the cellulosic paper surface was also confirmed by water absorption measurements. Normal filter paper absorbed a water droplet within a 6 second, whereas L-lactide treated cellulose displayed slower water droplet absorption than un-derivatized cellulose, corroborating a mainly PLLA modification of the normally hydrophilic cellulose since tartaric acid lacks hydrophobic functional groups. In the FT-IR spectrum of PLLA derivatized cellulose there are carbonyl peaks in both the Bronsted acid catalyzed sample and in the sample treated with L-lactide without addition of acid catalyst. The slow polymerization of L-lactide and cellulose derivatization that occurred without catalyst addition is plausibly autocatalytic, thermally driven and moisture initiated. The PLLA formation and cellulose derivatization was considerably faster in the presence of tartaric acid and yielded significantly higher molecular weights. Complete conversion was achieved within 18 h and the resulting PLLA had an average molecular weight of 1900 Da, which corresponds to a DP of 22. However, without the Bronsted acid catalyst present only oligomers were obtained with low conversion even after 18 h. Importantly, the PLLA was formed without significant racemazation under the set reaction conditions as determined by optical rotation and chiral-phase GC analyses. In addition, decreasing the catalyst loading and the initiator to monomer ratio increased the molecular weight of the PLLA. The cellulose is initiating the polymerization of L-lactide by ring opening of the monomer to form a di-mer with a reactive secondary alcohol, which is propagated. Thus, we show for the first time that a less reactive secondary alcohol containing monomer, L-lactide, also can be used in organic acid-catalyzed ROPs. In addition, D-lactide can be used as the monomer and the corresponding poly(D-lactic acid) cellulose fiber is formed.

Mandelic Acid Derivatization of Cellulose.

The Bronsted acid catalytic esterification of the hydroxyl groups of cellulose was corroborated by the successful esterification using D-mandelic acid. The carbonyl peak in FIG. 5 confirmed the D-mandelic acid esterification of cellulose. It was also shown that D-mandelic acid autocatalytically derivatized the cellulose. Since both tartaric acid and mandelic acid are α-hydroxy organic acids, direct asymmetric bulk esterification of cellulose using D-mandelic acid occurred. Control experiments were tartaric acid was dissolved in DMSO and reacted with the cellulose did not lead to esterification of the tartaric acid. In addition, no esterification was observed when mandelic acid was dissolved in DMSO. Thus, a high concentration of the organic acid is needed. Moreover, heating simply tartaric acid together with cellulose did not result in attachment of tartaric acid to the cellulose.

Derivatization of Polysaccharides with Chiral Molecules.

We found that chiral cyclic lactones such as L-lactide can be utilized as substrates for Bronsted acid-catalyzed and cellulose-initiated ROPs furnishing cellulose-chiral polyester products. Notably, the Bronsted acid-catalyzed ROP of chiral lactones are environmentally benign and can be readily performed with either enantiomer of lactide enabling different properties of poly(lactic acid)-cellulose products. Moreover, the intrinsic property of mandelic acid, as an α-hydroxy acid, can be used for the direct bulk autocatalytic esterification of cellulose. Thus, a novel organocatalytic route for polysaccharide-based CPS production useful for carboxylic-containing optically active compounds is presented.

1. A process for the modification of amines and alcohols, comprising (i) providing a substrate having amino groups or alcohol groups, wherein said substrate is a polysaccharide, an oligosaccharide, a silica, a protein, a peptide, a dendrimer, a fullerene, a polynucleotide, an oligonucleotide, a mononucleotides, an aliphatic or aromatic polymer or oligomer, a poly(hydroxyalkanoate), or a polyhydroxy compound;
(ii) providing a modifying agent which is a lactone, an ester, a polyester, a carbonate, a polycarbonate, a lactide, a glycolide, an anhydride, an acid, a thioester or a carbamate;
(iii) providing a catalyst which is an amino acid, a peptide or a derivative thereof, an oligopeptide, H₂O, a sulfonic acid, a tetrazole or an organic acid; and
(iv) reacting the substrate with the modifying agent in the presence of the catalyst.

2. A process according to claim 1, wherein the substrate is a compound according to the formulas
R—C(—OH)—R^{a} or R—C(—NH₂)—R^{a}
wherein R is a polyhydroxy compound, an aliphatic or aromatic polymer, a dendrimer, a silica, a polysaccharide, an oligosaccharide, a fullerene, a polynucleotide, an oligonucleotide, a mononucleotide, an aliphatic or aromatic oligomer, or a poly(hydroxyalkanoate) ; and R^{a} is R or hydrogen.

3. A process according to claim 1, wherein the substrate is a polysaccharide.

4. A process according to claim 3, wherein the substrate is cellulose.

5. A process according to claim 3, wherein the substrate is lignocellulose, hemicellulose or starch.

6. A process according to claim 1, wherein the acid acting as a modifying agent is a carboxylic acid.

7. A process according to claim 1, wherein the modifying agent is a compound according to the formula HO(O=)C—R^{b}, wherein R^{b} is alkyl, alkyn, alkenyl, polyhydroxy, aryl, aliphatic polymer, aromatic polymer, aliphatic oligomer, aromatic oligomer or poly(hydroxyalkanoate).

8. A process according to claim 1, wherein the modifying agent is a compound according to the formula R^{c}O(O═)C—R^{d}, wherein R^{c} is alkyl, aryl or vinyl; and R^{d} is alkyl, alkyn, alkenyl, polyhydroxy, aryl, aliphatic or aromatic polymer, aliphatic or aromatic oligomer, poly(hydroxyalkanoate), aliphatic or aromatic amine, or alkoxy.

9. A process according to claim 1, wherein the modifying agent is a compound according to the formula R⁸S(O═)C—R^{f}, wherein R^{e} is alkyl; and R^{f} is alkyl, alkyn, alkenyl, polyhydroxy or aryl.

10. A process according to claim 1, wherein the modifying agent is a compound according to the formula 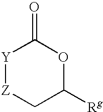
wherein n is 0 to 3; Y and Z independently are CH₂, CHOH, 0, NH or CH-halogen such as CH—Br, CH—Cl or CH—F; and R^{g} is alkyl, alkenyl, glycolide or lactide.

11. A process according to claim 1, wherein the modifying agent is a lactide.

12. A process according to claim 11, wherein the modifying agent is ε-caprolactone.

13. A process according to claim 1, wherein the modifying agent has alkyne, azide or phenol functionality.

14. A process according to claim 1, wherein the catalyst is an amino acid or an organic acid.

15. A process according to claim 14, wherein the catalyst is an organic acid.

16. A process according to claim 15, wherein catalyst is an α-hydroxy acid such as tartaric acid, lactic acid or citric acid.

17. A process according to claim 16, wherein the modifying agent is the same as the catalyst.

18. A process according to claim 1, wherein the organic acid acting as a catalyst is fumaric acid, malic acid, an α-hydroxy acid, ascorbic acid or mandelic acid.

19. A process according to claim 18, wherein the organic acid acting as a catalyst is an α-hydroxy acid such as tartaric acid, lactic acid or citric acid.

20. A process according to claim 1, wherein the substrate is present in solid phase.

21. A process according to claim 1, wherein said reaction is performed without additional solvent.

22. A process according to claim 1, wherein said reaction is a ring-opening polymerization.
